(19) United States
(12) Patent Application Publication
(10) Pub. No.: US 2026/0302445 A1
(43) Pub. Date: Oct. 1, 2026

(54) SECONDARY BATTERY, CASE FOR SECONDARY BATTERY AND METHOD FOR MANUFACTURING SECONDARY BATTERY

(71) Applicant: SAMSUNG SDI CO., LTD., Yongin-si (KR)

(72) Inventors: Jun Sik KIM, Yongin-Si (KR); Inseop BYUN, Yongin-Si (KR)

(21) Appl. No.: 19/575,309

(22) Filed: Mar. 23, 2026

(30) Foreign Application Priority Data
Mar. 25, 2025 (KR) 10-2025-0037688

(51) Int. Cl. H01M 50/15; H01M 10/04; H01M 10/0525; H01M 50/103; H01M 50/119; H01M 50/159; H01M 50/166

(52) U.S. Cl. CPC H01M 50/15; H01M 10/049; H01M 10/0525; H01M 50/103; H01M 50/119; H01M 50/159; H01M 50/166

(57) ABSTRACT

A secondary battery case includes: a body having an opening at one end, and an accommodating space for accommodating an electrode assembly; and a cover coupled to the one end with the opening to seal the accommodating space, the cover being recessed from the opening toward the accommodating space. An outer end of the cover is coupled to an inner end of the body.

### CROSS-REFERENCE TO RELATED APPLICATION

The present application claims priority to and the benefit of Korean Patent Application No. 10-2025-0037688, filed on March 25, 2025, in the Korean Intellectual Property Office, the entire disclosure of which is incorporated by reference herein.

### BACKGROUND

### 1. Field

Aspects of embodiments of the present disclosure relate to a secondary battery, a case for the secondary battery, and a method for manufacturing the secondary battery.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the electrode assembly, and electrode terminals connected to the electrode assembly.

Aluminum alloys have been used for a case of the secondary battery that is used in small-sized electronic devices due to having a lightweight, formability, and cost-effectiveness. However, the case may suffer damage for complex reasons during various manufacturing processes. Accordingly, technologies related to a SUS (Stainless Use Steel) can kind of secondary batteries, which use stainless steel instead of aluminum as the case material, are being actively researched.

A secondary battery having a high energy density (e.g., the amount of energy stored per unit volume) may provide a longer running time in portable devices, or a longer driving range in electric vehicles. Accordingly, the energy density of a secondary battery may be one of the important key factors for determining the performance of the secondary battery.

The above information disclosed in this Background section is for enhancement of understanding of the background of the present disclosure, and therefore, it may contain information that does not constitute related (or prior) art.

### SUMMARY

Embodiments of the present disclosure may be directed to a secondary battery, a case for the secondary battery, and a method for manufacturing the secondary battery.

However, the present disclosure is not limited to the above aspects and features, and the above and additional aspects and features will be set forth, in part, in the description that follows, and in part, may be apparent from the description.

According to one or more embodiments of the present disclosure, a secondary battery case includes: a body having an opening at one end, and an accommodating space for accommodating an electrode assembly; and a cover coupled to the one end with the opening to seal the accommodating space, the cover being recessed from the opening toward the accommodating space. An outer end of the cover is coupled to an inner end of the body.

In an embodiment, the body may include: a body base; and a body flange extending by being bent from the body base, and surrounding around the body base. The cover may include: a cover base spaced from the body base with the accommodating space therebetween; and a cover flange extending by being bent from the cover base, and surrounding around the cover base, the cover flange being coupled to an inner side of the body flange.

In an embodiment, an extension direction of the cover flange may be same as an extension direction of the body flange.

In an embodiment, a bending angle of the body flange and a bending angle of the cover flange may be same as each other, and the bending angle of the body flange and the bending angle of the cover flange may be from 75 degrees to 90 degrees.

In an embodiment, a bending angle of the body flange may be smaller than a bending angle of the cover flange.

In an embodiment, a bending angle of the body flange may be greater than a bending angle of the cover flange.

In an embodiment, a length from an outer peripheral surface of the cover base to one end of the cover flange may be between 0.2 mm and 0.4 mm.

In an embodiment, a length from an outer peripheral surface of the cover base to one end of the cover flange may be 7% or more and 15% or less than a length from an inner peripheral surface of the body base to one end of the body flange.

In an embodiment, a thickness of the body may be one time or two times a thickness of the cover.

In an embodiment, the body and the cover may include a same metal material as each other.

In an embodiment, the metal material may include stainless use steel.

According to one or more embodiments of the present disclosure, a secondary battery includes: an electrode assembly including a first electrode, a separator, and a second electrode; a body including one end with an opening, and an accommodating space accommodating the electrode assembly; and a cover coupled to the one end with the opening to seal the accommodating space, the cover being recessed from the opening toward the accommodating space. An outer end of the cover is coupled to an inner end of the body.

In an embodiment, the body may include: a body base; and a body flange extending by being bent from the body base, and surrounding around the body base. The cover may include: a cover base spaced from the body base with the accommodating space therebetween; and a cover flange extending by being bent from the cover base to surround around the cover base, and coupled to an inner side of the body flange.

In an embodiment, the cover base may be configured to be deformable in an extension direction of the cover flange when the electrode assembly expands in a direction perpendicular to the body base and the cover base.

In an embodiment, an extension direction of the cover flange may be same as an extension direction of the body flange.

In an embodiment, a length from an outer peripheral surface of the cover base to one end of the cover flange may be 7% or more and 15% or less than a length from an inner peripheral surface of the body base to one end of the body flange.

According to one or more embodiments of the present disclosure, a method for manufacturing a secondary battery includes: preparing an opening at one end of a body of a case, and an accommodating space for accommodating an electrode assembly in the body; inserting the electrode assembly into the accommodating space; arranging a cover recessed toward the accommodating space in the opening; pressing the cover to be in contact with the electrode assembly; and coupling an outer end of the cover to an inner end of the body.

In an embodiment, the body may include: a body base; and a body flange extending by being bent from the body base, and surrounding around the body base. The cover may include: a cover base spaced from the body base with the accommodating space therebetween; and a cover flange extending by being bent from the cover base to surround around the cover base, and coupled to an inner side of the body flange.

In an embodiment, in the pressing of the cover, an outer peripheral surface of the electrode assembly may be in contact with one surface of the body base and one surface of the cover base.

In an embodiment, the method may further include: cutting one end of the body flange and the cover flange that are coupled to each other to be parallel to the body base.

According to some embodiments of the present disclosure, a secondary battery may be provided in which an accommodating space for accommodating an electrode assembly may be sealed by arranging an outer end of a case cover to be in contact with an inner end of a case body. Accordingly, an extra space that may cause energy density loss as a side space of the body may be eliminated or reduced, and the extra space in an extension direction of a body flange during a manufacturing process of the secondary battery may be reduced, thereby achieving a higher energy density.

According to some embodiments of the present disclosure, a secondary battery case structure considering a direction of a swelling phenomenon that may occur as a result of repeated charging and discharging during a use of the secondary battery may be provided. Accordingly, a volume change of the secondary battery due to the swelling phenomenon may be minimized or reduced, and the extra space in the extension direction of the body flange may be eliminated or reduced, thereby providing a secondary battery having improved energy density.

According to some embodiments of the present disclosure, by using a body and a cover of the case in a double cup shape, the cover may be pressed in a direction toward the electrode assembly accommodated in the body of the case during a secondary battery manufacturing process. As a result, the electrode assembly accommodated in the body may be uniformly or substantially uniformly adhered, thereby inducing an excellent electrochemical reaction without side reactions.

According to some embodiments of the present disclosure, a thickness of the body of the case may be formed to be equal to or greater than a thickness of the cover, thereby improving a deep-drawing formability of the body, and ensuring a strength of the secondary battery.

However, the present disclosure is not limited to the above aspects and features, and the above and additional aspects and features will be set forth, in part, in the detailed description that follows with reference to the drawings, and in part, may be apparent therefrom, or may be learned by practicing one or more of the presented embodiments of the present disclosure.

### BRIEF DESCRIPTION OF THE DRAWINGS

The above and other aspects and features of the present disclosure will be more clearly understood from the following detailed description of the illustrative, non-limiting embodiments with reference to the accompanying drawings, in which:

FIG. 1 is an exploded perspective view illustrating an example of a secondary battery according to some embodiments of the present disclosure;

FIG. 2 is a perspective view illustrating an example of a secondary battery according to some embodiments of the present disclosure;

FIG. 3 is a cross-sectional view illustrating an example of a secondary battery according to a comparative example;

FIG. 4 is a cross-sectional view illustrating an example of a secondary battery according to some embodiments of the present disclosure;

FIG. 5 is a cross-sectional view illustrating a body and a cover of a case for a secondary battery according to some embodiments of the present disclosure;

FIG. 6 is a side view illustrating a secondary battery of FIG. 2 according to some embodiments of the present disclosure;

FIG. 7 is an enlarged view illustrating the area B of FIG. 6 according to an embodiment of the present disclosure;

FIG. 8 is an enlarged view illustrating the area B of FIG. 6 according to an embodiment of the present disclosure;

FIG. 9 is a cross-sectional view illustrating a thickness of a body and a cover of a secondary battery according to some embodiments of the present disclosure;

FIG. 10 is a cross-sectional view illustrating an example in which bending angles of a body flange and a cover flange are the same as each other;

FIG. 11 is a cross-sectional view illustrating an example in which bending angles of a body flange and a cover flange are the same as each other;

FIG. 12 is a cross-sectional view illustrating an example in which bending angles of a body flange and a cover flange are different from each other;

FIG. 13 is a cross-sectional view illustrating an example in which bending angles of a body flange and a cover flange are different from each other;

FIG. 14 is a cross-sectional view illustrating a state before an electrode assembly is expanded in a secondary battery according to some embodiments of the present disclosure;

FIG. 15 is a cross-sectional view illustrating a state after an electrode assembly is expanded in a secondary battery according to some embodiments of the present disclosure;

FIG. 16 is a view illustrating an example of a portion in which a body flange is coupled to a cover flange;

FIG. 17 is a flowchart illustrating an example of a method for manufacturing a secondary battery according to some embodiments of the present disclosure; and

FIG. 18 is a cross-sectional view illustrating an example of pressing a cover in a method for manufacturing a secondary battery according to some embodiments of the present disclosure.

### DETAILED DESCRIPTION

Hereinafter, embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, redundant description thereof may not be repeated.

When a certain embodiment may be implemented differently, a specific process order may be different from the described order. For example, two consecutively described processes may be performed at the same or substantially at the same time, or may be performed in an order opposite to the described order.

Further, as would be understood by a person having ordinary skill in the art, in view of the present disclosure in its entirety, each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner, unless otherwise stated or implied.

In the drawings, the relative sizes, thicknesses, and ratios of elements, layers, and regions may be exaggerated and/or simplified for clarity. Spatially relative terms, such as “beneath,” “below,” “lower,” “under,” “above,” “upper,” and the like, may be used herein for ease of explanation to describe one element or feature’s relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

Further, it should be expected that the shapes shown in the figures may vary in practice depending, for example, on tolerances and/or manufacturing techniques. Accordingly, the embodiments of the present disclosure should not be construed as being limited to the specific shapes shown in the figures, and should be construed considering changes in shapes that may occur, for example, as a result of manufacturing. As such, the shapes shown in the drawings may not depict the actual shapes of areas of the device, and the present disclosure is not limited thereto.

Any numerical range disclosed and/or recited herein is intended to include all sub-ranges of the same numerical precision subsumed within the recited range. For example, a range of "1.0 to 10.0" is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited herein is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, and the like as being “the same” as each other may mean that they are “substantially the same” as each other. Thus, the phrase “substantially the same” may include a case having a deviation or a variation that is considered low in the art, for example, such as a deviation or a variation of 5% or less. In addition, when a certain parameter is referred to as being uniform in a given region, it may mean that it is uniform in terms of an average.

In the figures, the x-axis, the y-axis, and the z-axis are not limited to three axes of the rectangular coordinate system, and may be interpreted in a broader sense. For example, the x-axis, the y-axis, and the z-axis may be perpendicular to or substantially perpendicular to one another, or may represent different directions from each other that are not perpendicular to one another.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “on,” “connected to,” or “coupled to” another element or layer, it can be directly on, connected to, or coupled to the other element or layer, or one or more intervening elements or layers may be present. Similarly, when a layer, an area, or an element is referred to as being "electrically connected" to another layer, area, or element, it may be directly electrically connected to the other layer, area, or element, and/or may be indirectly electrically connected with one or more intervening layers, areas, or elements therebetween. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments and is not intended to be limiting of the present disclosure. As used herein, the singular forms “a” and “an” are intended to include the plural forms as well, unless the context clearly indicates otherwise. It will be further understood that the terms “comprises,” “comprising,” "includes," "including," "has," "have," and "having," when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, the expression "A and/or B" denotes A, B, or A and B. Expressions such as “at least one of,” when preceding a list of elements, modify the entire list of elements and do not modify the individual elements of the list. For example, the expression "at least one of a, b, or c," “at least one of a, b, and c,” and “at least one selected from the group consisting of a, b, and c” indicates only a, only b, only c, both a and b, both a and c, both b and c, all of a, b, and c, or variations thereof.

As used herein, the term "substantially," "about," and similar terms are used as terms of approximation and not as terms of degree, and are intended to account for the inherent variations in measured or calculated values that would be recognized by those of ordinary skill in the art. Further, the use of “may” when describing embodiments of the present disclosure refers to “one or more embodiments of the present disclosure.” As used herein, the terms "use," "using," and "used" may be considered synonymous with the terms "utilize," "utilizing," and "utilized," respectively.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

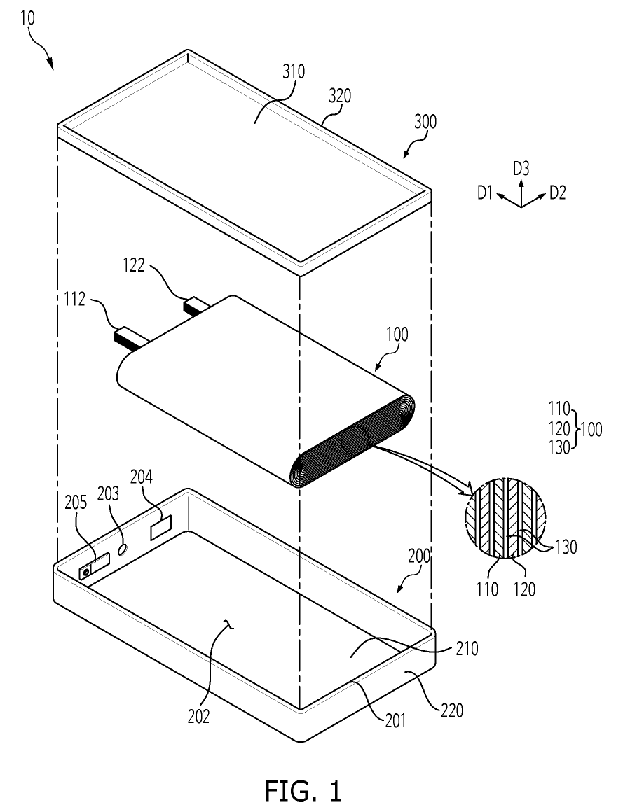

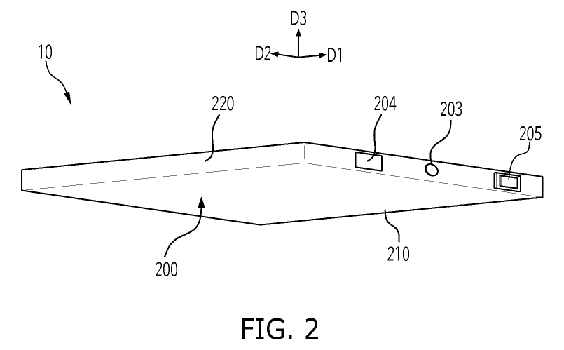

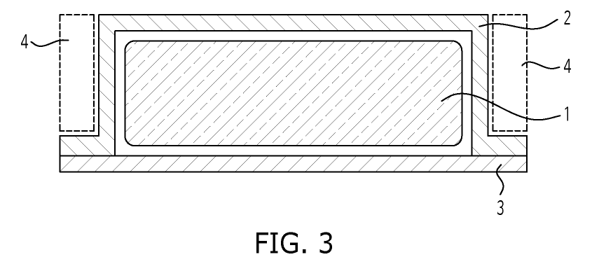

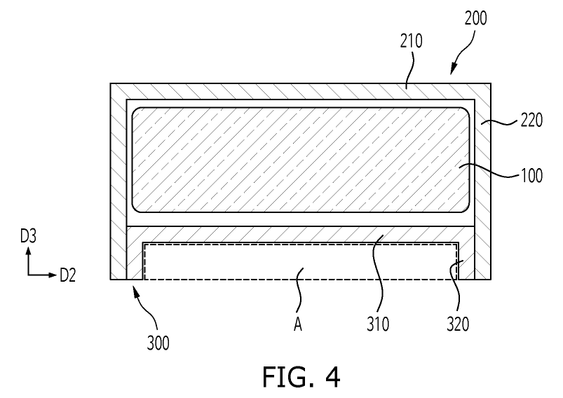

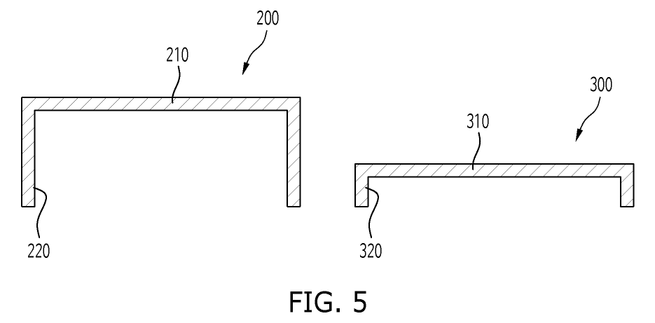

FIG. 1 is an exploded perspective view illustrating an example of a secondary battery according to some embodiments of the present disclosure. FIG. 2 is a perspective view illustrating an example of a secondary battery according to some embodiments of the present disclosure. FIG. 3 is a cross-sectional view illustrating an example of a secondary battery according to a comparative example. FIG. 4 is a cross-sectional view illustrating an example of a secondary battery according to some embodiments of the present disclosure. FIG. 5 is a cross-sectional view illustrating a body and a cover of a case for a secondary battery according to some embodiments of the present disclosure.

A secondary battery 10 may include an electrode assembly 100, a body 200 including an accommodating space 202 for accommodating the electrode assembly 100, and a cover 300 coupled to the body. The electrode assembly 100 may include a first electrode 110, a separator 130, and a second electrode 120. For example, the electrode assembly 100 may be wound or stacked by disposing the separator 130, which is an insulator, between the first electrode 110 and the second electrode 120.

The first electrode 110 may include a first substrate, and a first active material layer disposed on the first substrate. A first electrode tab 112 may extent outward from a non-coated part of the first substrate where the first active material layer is not disposed. The second electrode 120 may include a second substrate, and a second active material layer disposed on the second substrate. A second electrode tab 122 may extend outward from a non-coated part of the second substrate where the second active material layer is not disposed. The electrode assembly 100 may have a suitable structure (e.g., an arbitrary structure) including electrode tabs 112 and 122.

The first electrode 110 may function as a positive electrode. In this case, the first substrate may be a positive electrode substrate. The positive electrode substrate may be made of an aluminum foil, and a positive electrode active material may include, for example, a transition metal oxide.

The positive electrode active material may include a compound (e.g., a lithiated intercalation compound) that is capable of intercalating and deintercalating lithium. In more detail, at least one of a composite oxide of lithium and/or a metal selected from cobalt, manganese, nickel, and/or suitable combinations thereof may be used.

The composite oxide may be a lithium transition metal composite oxide. Some examples of the composite oxide may include a lithium nickel-based oxide, a lithium cobalt-based oxide, a lithium manganese-based oxide, a lithium iron phosphate-based compound, a cobalt-free nickel-manganese-based oxide, or a suitable combination thereof.

As an example, the following compounds represented by any one of the following Chemical Formulas may be used. LiaA1-bXbO2-cDc (0.90≤a≤1.8, 0≤b≤0.5, and 0≤c≤0.05); LiaMn2-bXbO4-cDc (0.90≤a≤1.8, 0≤b≤0.5, and 0≤c≤0.05); LiaNi1-b-cCobXcO2-αDα (0.90≤a≤1.8, 0≤b≤0.5, 0≤c≤0.5, and 0<α<2); LiaNi1-b-cMnbXcO2-αDα (0.90≤a≤1.8, 0≤b≤0.5, 0≤c≤0.5, and 0<α<2); LiaNibCocL1dGeO2 (0.90≤a≤1.8, 0≤b≤0.9, 0≤c≤0.5, 0≤d≤0.5, and 0≤e≤0.1); LiaNiGbO2 (0.90≤a≤1.8 and 0.001≤b≤0.1); LiaCoGbO2 (0.90≤a≤1.8 and 0.001≤b≤0.1); LiaMn1-bGbO2 (0.90≤a≤1.8 and 0.001≤b≤0.1); LiaMn2GbO4 (0.90≤a≤1.8 and 0.001≤b≤0.1); LiaMn1-gGgPO4 (0.90≤a≤1.8 and 0≤g≤0.5); Li(3-f)Fe2(PO4)3 (0≤f≤2); or LiaFePO4 (0.90≤a≤1.8).

In the above Chemical Formulas, A is Ni, Co, Mn, or a combination thereof; X is Al, Ni, Co, Mn, Cr, Fe, Mg, Sr, V, a rare earth element or a combination thereof; D is O, F, S, P, or a combination thereof; G is Al, Cr, Mn, Fe, Mg, La, Ce, Sr, V, or a combination thereof; and L1 is Mn, Al, or a combination thereof.

The positive electrode active material may be, for example, a high nickel-based positive electrode active material having a nickel content of greater than or equal to about 80 mol%, greater than or equal to about 85 mol%, greater than or equal to about 90 mol%, greater than or equal to about 91 mol%, or greater than or equal to about 94 mol%, and less than or equal to about 99 mol% based on 100 mol% of the metal excluding lithium in the lithium transition metal composite oxide. The high-nickel-based positive electrode active material may be capable of realizing a high capacity, and may be applied to a high-capacity, high-density rechargeable lithium battery.

The second electrode 120 may function as a negative electrode. In this case, the second substrate may be a negative electrode substrate. The negative electrode substrate may be made of, for example, a copper foil or a nickel foil, and a negative electrode active material may include, for example, graphite.

The negative electrode active material may include a suitable material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example. crystalline carbon, amorphous carbon, or a suitable combination thereof. The crystalline carbon may be graphite, such as non-shaped, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and/or the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and/or Sn.

The material capable of doping/dedoping lithium may be a Si-based negative electrode active material or a Sn-based negative electrode active material. The Si-based negative electrode active material may include silicon, a silicon-carbon composite, SiOx (0 < x < 2), or a Si-Q alloy (where Q is selected from an alkali metal, an alkaline-earth metal, a Group 13 element, a Group 14 element (excluding Si), a Group 15 element, a Group 16 element, a transition metal, a rare earth element, and/or a suitable combination thereof). The Sn-based negative electrode active material may include Sn, SnO2, a Sn-based alloy, or a suitable combination thereof.

The silicon-carbon composite may be a composite of silicon and amorphous carbon. According to an embodiment, the silicon-carbon composite may be in a form of silicon particles, and amorphous carbon coated on a surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and for example, the primary silicon particles may be coated with the amorphous carbon. The secondary particle may exist dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material or the Sn-based negative electrode active material may be used in combination with a carbon-based negative electrode active material.

The separator 130 may include polyethylene, polypropylene, polyvinylidene fluoride, or a multilayered film of two or more layers thereof, and a mixed multilayered film, such as a polyethylene/polypropylene two-layered separator, polyethylene/polypropylene/polyethylene three-layered separator, polypropylene/polyethylene/polypropylene three-layered separator, and/or the like.

The separator may include a porous substrate, and a coating layer including an organic material, an inorganic material, or a combination thereof on one or both surfaces of the porous substrate.

The porous substrate may be a polymer film formed of any one selected polymer polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic material and the inorganic material may be mixed in one coating layer, or a coating layer including an organic material and a coating layer including an inorganic material may be stacked.

The body 200 may have an opening 201 formed at one end (e.g., one end in the D3 direction of the body 200). The body 200 may have one end where the opening 201 is formed to be open to accommodate the electrode assembly 100. The body 200 may have one open end, and may include an accommodating space 202 that accommodates the electrode assembly 100.

The accommodating space 202 that accommodates the electrode assembly 100 may be formed around the center area of the body 200 by a press processing and the like. According to some embodiments, the accommodating space 202 may be defined by a body flange 220 that extends from a body base 210 and an edge of the body base 210.

The electrode assembly 100 may be inserted into the opening 201 of the body 200, and may be accommodated in the accommodating space 202. The cover 300 may be coupled to the end with the opening 201 of the body 200 to seal the accommodating space 202.

A negative electrode terminal 204 and a positive electrode terminal 205 may be arranged on a side (e.g., one side of the body 200 in the D1 direction) different from the open end. For example, the body 200 may include an electrolyte injection hole 203. For example, the electrolyte injection hole 203 may be a through hole formed on the side of the body 200. The electrolyte injection hole 203 may be formed to inject an electrolyte into the inside of the body 200 of the secondary battery 10 after the body 200 and the cover 300 are bonded and sealed together. The electrolyte injection hole 203 may be sealed by a sealing member after the electrolyte is injected.

The electrolyte injection hole 203 is illustrated as being disposed between a pair of the electrode terminals 204 and 205, but the present disclosure is not limited thereto, and the electrolyte injection hole 203 may be disposed in any suitable location or may be omitted as needed or desired.

According to an embodiment, the pair of electrode terminals 204 and 205 may be arranged on the side of the body 200. For example, the negative electrode terminal 204 and the positive electrode terminal 205 may be disposed on opposite sides in the D2 direction with respect to the electrolyte injection hole 203.

The positive electrode terminal 205 may be electrically connected to the first electrode tab 112 of the electrode assembly 100, and the negative electrode terminal 204 may be electrically connected to the second electrode tab 122 of the electrode assembly 100. The positions of the positive electrode terminal 205 and the negative electrode terminal 204 are not limited to the positions illustrated in FIG. 1, and may be variously modified as needed or desired.

The body 200 may include the body base 210 and the body flange 220. According to some embodiments, the body 200 may include the body flange 220 that surrounds (e.g., around a periphery of) the body base 210. For example, the body flange 220 perpendicular to or substantially perpendicular to the body base 210 may be formed along the periphery of the body base 210. When the body base 210 is polygonal, a plurality of body flanges 220 respectively corresponding to a plurality of sides (e.g., edges) of the body base 210 may be formed.

The body base 210 of the body 200 may have a suitable shape (e.g., an arbitrary shape). For example, the body base 210 may have a square shape. In this case, the body flange 220 may be formed by surrounding (e.g., around a periphery of) four (4) sides of the body base 210 having the square shape. As another example, the body base 210 may have a circular shape. In this case, the body flange 220 may be formed by surrounding around the periphery of the body base 210 having the circular shape.

The body flange 220 may extend by bending from the body base 210. For example, the body flange 220 may extend by bending in the D3 direction from the body base 210. The body flange 220 may be formed to surround (e.g., around a periphery of) the body base 210. The body flange 220 may be formed with four (4) flanges that extend in the D3 direction from the body base 210. The negative electrode terminal 204 and the positive electrode terminal 205 may be disposed on at least one surface of the body flange 220.

One end of the body 200 may be opened. For example, the body 200 may be in the form of a cylinder or may have a cylindrical shape with one of two bottom faces thereof omitted. The entire shape of the body 200 may have a flat or substantially flat cup shape. For example, the body 200 may have a cup shape with an open side opposite to the body base 210. The opening 201 of the body 200 may be disposed at one end of the body flange 220.

The cover 300 may be recessed toward the accommodating space 202 from the opening 201 of the body 200. An outer end of the cover 300 may be coupled to an inner end of the body 200. In more detail, the cover 300 may include a cover base 310 and a cover flange 320. The cover 300 may include the cover base 310, and the cover flange 320 that surrounds (e.g., around a periphery of) the cover base 310. For example, the cover flange 320 perpendicular to or substantially perpendicular to the cover base 310 may be formed along a periphery of the cover base 310. When the cover base 310 has a polygonal shape, a plurality of cover flanges 320 respectively corresponding to a plurality of sides (e.g., edges) of the cover base 310 may be formed.

The cover 300 may be accommodated inside the body 200. For example, the cover 300 may be accommodated inside the body 200 so that the cover base 310 of the cover 300 may seal the opening 201 of the body 200. In more detail, the cover 300 may be accommodated inside the body 200 so that the cover base 310 of the cover 300 may be in parallel to or substantially in parallel to the body base 210 of the body 200 to seal the open end of the body 200, and at least a part of the outer peripheral surface of the cover flange 320 may contact at least a part of the inner peripheral surface of the body flange 220. The cover 300 may have a cup shape smaller than that of the body 200. For example, the height of the cover flange 320 may be smaller than that of the body flange 220.

The cover base 310 may be spaced apart from the body base 210 with the accommodating space 202 disposed therebetween. The cover base 310 of the cover 300 may be in parallel to or substantially in parallel to the body base 210 of the body 200. The cover base 310 may have a suitable shape (e.g., an arbitrary shape). For example, the cover base 310 may have a square shape. In this case, the cover flange 320 may be formed by surrounding (e.g., around a periphery of) four (4) sides of the cover base 310 having a square shape. As another example, the cover base 310 may have a circular shape. In this case, the cover flange 320 may be formed by surrounding (e.g., around a periphery of) the circumference of the cover base 310 having a circular shape.

The cover base 310 may have a smaller area than that of the body base 210. Accordingly, the cover 300 may be recessed into the inside of the body 200, so that the outer end of the cover 300 may be coupled to the inner end of the body 200.

The cover flange 320 may extend by bending from the cover base 310. For example, the cover flange 320 may extend by bending in the D3 direction from the cover base 310. The cover flange 320 may be formed to surround (e.g., around a periphery of) the cover base 310. According to some embodiments, the cover flange 320 may be formed with four (4) flanges that extend in the D3 direction from the cover base 310.

The cover flange 320 may be coupled to the inside of the body flange 220. For example, four (4) cover flanges 320 may be respectively coupled to the inner sides of the body flanges 220 with respective outer surfaces arranged in corresponding directions.

One end of the cover 300 may be opened. For example, the cover 300 may be in the form of a cylinder or have a cylindrical shape with one of the two bottom faces omitted. The entire shape of the cover 300 may have a flat or substantially flat cup shape. For example, the cover 300 may have a cup shape with an open surface opposite to the cover base 310.

One end of the cover 300 (e.g., one end of the cover 300 in the D3 direction) may be opened, and an available space A may be formed inside the cover 300. The available space A may be formed around a center area of the cover 300 by a press processing. According to some embodiments, the available space A may be formed by the cover base 310 and the cover flange 320 that extends form an edge of the cover base 310.

The cover 300 may be coupled to the opening 201 of the body 200. The body 200 may be bonded to the cover 300 to form the exterior of the secondary battery 10. For example, the cover 300 may have a cup shape arranged on the top of the body 200 to seal the accommodating space 202 of the body 200. The cover 300 may be formed in a cup shape having a suitable size to cover the opening 201, and the body flange 220 and the cover flange 320 may be bonded to each other by a surface contact. In more detail, the inner surface of the body flange 220 may be in surface contact with the outer surface of the cover flange 320. The body 200 and the cover 300 may form the secondary battery case as the inner surface of the body flange 220 is bonded to the outer surface of the cover flange 320.

FIG. 3 illustrates a cross-sectional view of a secondary battery according to a comparative example, and shows an available space 4 due to the flange that protrudes to the side of a body 2 and a cover 3. The body 2 according to the comparative example may have a planar part on one surface bonded to the cover 3, and the cover 3 in a flat plate shape may seal the space that accommodates an electrode assembly 1. After the body 2 is bonded to the cover 3, part of the flange that protrudes to the side may be cut by using a laser.

According to the comparative example, due to the available space 4, a volume utilization of the space to which a secondary battery is applied may be limited. Therefore, the energy density of the secondary battery may be reduced.

According to some embodiments of the present disclosure, in the secondary battery shown in FIG. 4, the body 200 and the cover 300 may be formed in a cup shape to remove the available space 4 according to the comparative example. A volume utilization of the space to which the secondary battery is applied may be maximized or improved, thereby increasing the energy density of the secondary battery.

Through a formation process in a manufacturing process of the secondary battery, the electrode assembly 100 may expand in the D3 direction. As the electrode assembly 100 expands, the cover 300 may be deformed downward or upward in the D3 direction. In this case, the available space A surrounded (e.g., around a periphery thereof) by the body flange 220 and the cover flange 320 may be reduced, thereby increasing the energy density of the secondary battery.

For example, the electrode assembly 100 may expand in the D3 direction by repeating charging and discharging during the use of the secondary battery. As the electrode assembly 100 expands, the cover 300 may be deformed downward or upward in the D3 direction. In this case, the available space A surrounded (e.g., around a periphery thereof) by the body flange 220 and the cover flange 320 may be removed or reduced. Therefore, a volume change of the secondary battery may be minimized or reduced, and the energy density of the secondary battery may be increased.

The configuration and elements of the secondary battery 10 shown in FIG. 1 are illustrated as an example, and other configurations and elements may be additionally included or omitted as needed or desired. For example, the shape, the location relationship, and the like of the configurations and elements of the secondary battery shown in FIG. 1 may variously modified as needed or desired.

The D1, D2, and D3 directions of FIG. 1 illustrate a length direction, a width direction, and a thickness direction of the secondary battery 10, respectively, or those of a configuration (e.g., the body 200, the electrode assembly 100, and the like) of the secondary battery 10.

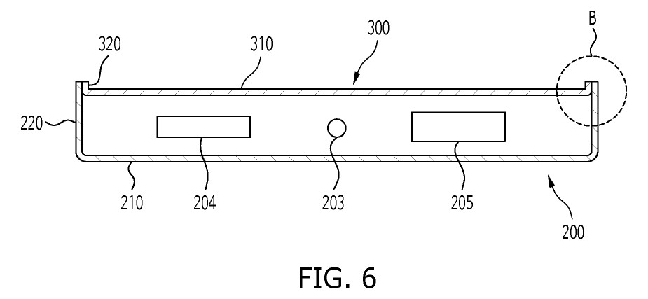

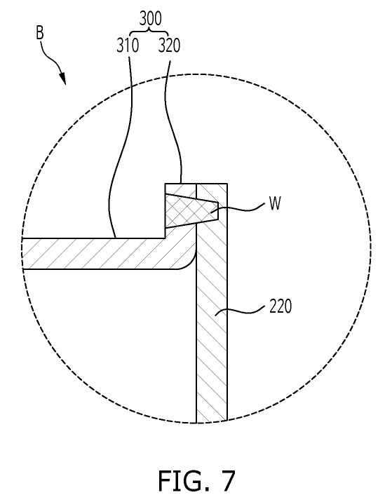

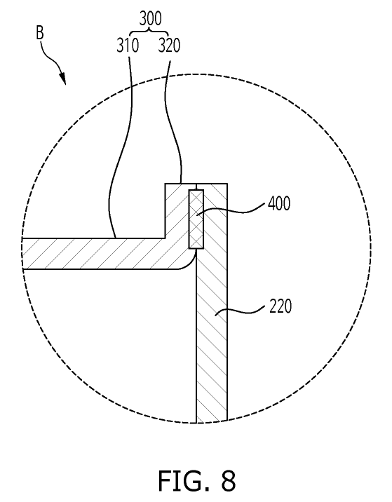

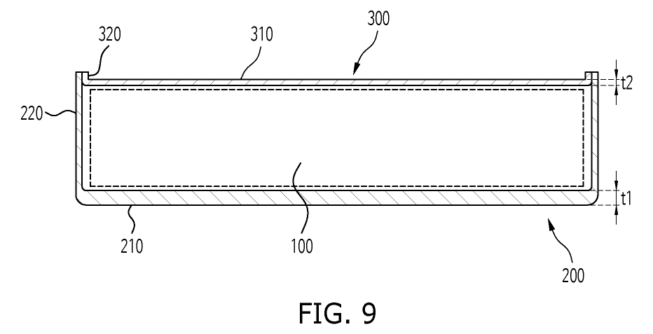

FIG. 6 is a side view illustrating a secondary battery of FIG. 2 according to some embodiments of the present disclosure. FIG. 6 is a side view when viewed from the D2 direction of FIG. 2 according to some embodiments of the present disclosure. FIG. 7 is an enlarged view illustrating the area B of FIG. 6 according to an embodiment of the present disclosure. FIG. 8 is an enlarged view illustrating the area B of FIG. 6 according to an embodiment of the present disclosure. FIG. 9 is a cross-sectional view illustrating a thickness of a body and a cover of a secondary battery according to some embodiments of the present disclosure.

At least one of the body 200 or the cover 300 may include stainless steel (SUS). The body 200 and/or the cover 300 may include stainless steel (SUS), and the secondary battery may be a SUS can kind of secondary battery, but the present disclosure is not limited thereto. For example, the body 200 and/or the cover 300 may be formed of a conductive metal, such as aluminum, an aluminum alloy, or a nickel-plated steel to form the overall exterior of the secondary battery.

The body 200 and the cover 300 may be made of the same metal material as each other. By forming the body 200 and the cover 300 of the same material as each other, a corrosion may be prevented or substantially prevented from occurring at a portion where the body 200 is bonded the cover 300 due to a potential difference between different metals. According to some embodiments, the metal material constituting the body 200 and the cover 300 may include stainless steel (stainless steel, SUS). The stainless steel material may include any suitable kind of stainless steel series material, such as SUS 304, SUS 316, SUS 420, or SUS 430, depending on the kind and a ratio of the alloy material within the stainless steel series.

The secondary battery may be a lithium battery cell, a sodium battery cell, or the like. However, the present disclosure is not limited thereto, and the secondary battery may include all suitable kinds of batteries that repeatedly provides electricity by charging and discharging. According to some embodiments, when the secondary battery is a lithium secondary battery, the lithium secondary battery may be used in an electric vehicle (EV) because of its excellent life characteristics and high-rate characteristics. For example, the lithium secondary battery may be used in a hybrid vehicle, such as a plug-in hybrid electric vehicle (PHEV). For example, the lithium secondary battery may be used in various suitable fields that require or desire a wide range of power storage, such as smartphones, tablet PCs, electric bicycles, power tools, and the like.

The negative electrode terminal 204 and the positive electrode terminal 205 may be arranged on opposites sides on one surface of the body flange 220 with respect to the electrolyte injection hole 203. The body 200 may be bonded to the cover 300 by laser welding. However, the bonding method is not limited thereto, and various suitable bonding methods may be used to seal the body 200.

For example, as shown in FIG. 7, the body 200 and the cover 300 may be bonded to each other by metal bonding (e.g., welding, brazing, soldering, and/or the like). In this case, the body flange 220 may be bonded to the cover flange 320 through a bonding part W. In more detail, the inner side of the body flange 220 may be bonded to the outer side of the cover flange 320.

As illustrated in FIG. 8, the body 200 and the cover 300 may be bonded to each other through a separate adhesive layer 400. The adhesive layer 400 may include at least one of a hot melt, a rubber, or an acrylic. For example, when the adhesive layer 400 includes a hot melt adhesive, the hot melt adhesive may include an acrylic resin, a synthetic rubber resin, a polyolefin resin, an ester resin, a urethane resin, an epoxy resin, or a silicone resin, but the present disclosure is not limited thereto. For example, a film may be impregnated with the hot melt adhesive by applying a molten hot melt adhesive solution to a film layer, or by impregnating the film layer with a hot melt adhesive solution dissolved in a solvent and then volatilizing the solvent. However, the present disclosure is not limited thereto, and various suitable impregnation methods of the hot melt adhesive may be used.

A thickness t1 of the body 200 may be formed to have a value that is one (1) to two (2) times a thickness t2 of the cover 300. For example, the thickness of the body 200 or the cover 300 may be between 0.05 mm and 0.3 mm, but the present disclosure is not limited thereto.

The body 200 may affect an entire rigidity of the secondary battery. When the thickness t1 of the body 200 is formed greater than the thickness t2 of the cover 300, a deep-drawing formation of the body 200 may be improved, and a strength of the secondary battery may be ensured.

A deep-drawing formation depth of the body 200 may be deeper than a deep-drawing formation depth of the cover 300. Therefore, the thickness t1 of the body 200 may have a value that is one (1) time or two (2) times the thickness t2 of the cover 300. For example, when the thickness t2 of the cover base 310 and the cover flange 320 is 0.1 mm, the thickness t1 of the body base 210 and the body flange 220 may be 0.2 mm .

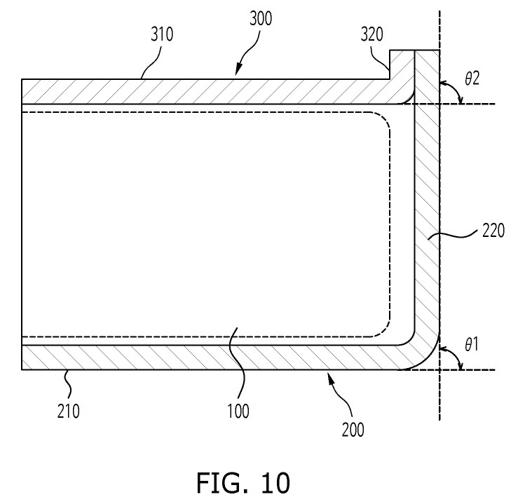

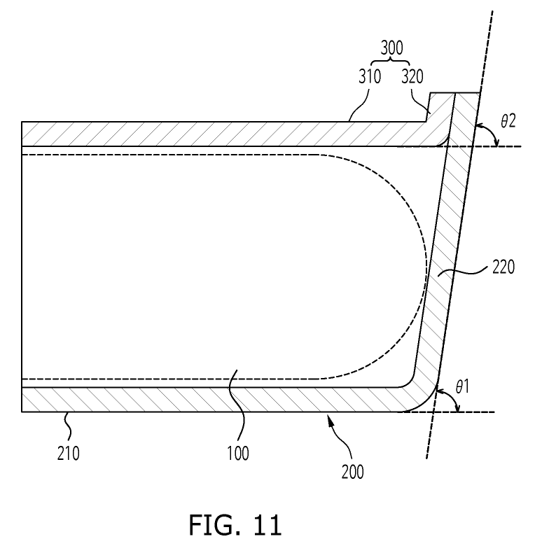

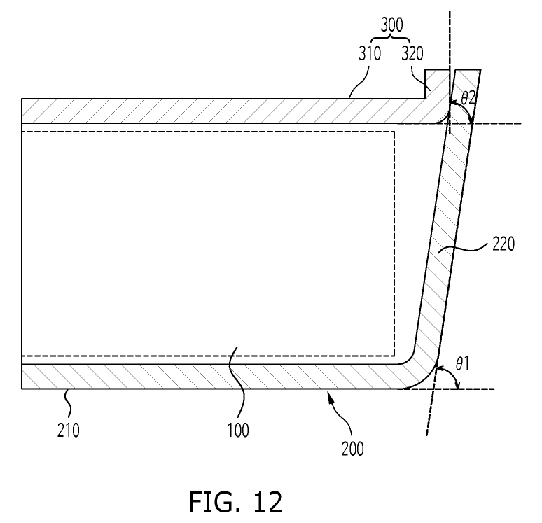

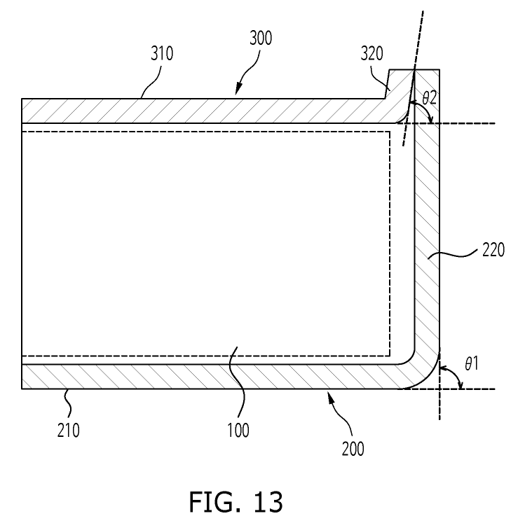

FIG. 10 is a cross-sectional view illustrating an example in which bending angles of a body flange and a cover flange are the same as each other. FIG. 11 is a cross-sectional view illustrating an example in which bending angles of a body flange and a cover flange are the same as each other. FIG. 12 is a cross-sectional view illustrating an example in which bending angles of a body flange and a cover flange are different from each other. FIG. 13 is a cross-sectional view illustrating an example in which bending angles of a body flange and a cover flange are different from each other.

Referring to FIG. 10 and FIG. 11, the extension direction of the cover flange 320 may be the same as the extension direction of the body flange 220. Accordingly, a bending angle θ1 of the body flange 220 may be formed to be the same as a bending angle θ2 of the cover flange 320. For example, the angle between the bending angle θ1 of the body flange 220 and the bending angle θ2 of the cover flange 320 may be between 75 degrees and 90 degrees. The bending angle θ1 of the body flange 220 may be the angle between the body base 210 and the body flange 220. The bending angle θ2 of the cover flange 320 may be the angle between the cover base 310 and the cover flange 320.

The body flange 220 may extend by bending from the body base 210 with a suitable angle (e.g., a predetermined angle). The cover flange 320 may extend by bending from the cover base 310 with a suitable angle (e.g., a predetermined angle). For example, FIG. 10 illustrates that the bending angle θ1 of the body flange 220 and the bending angle θ2 of the cover flange 320 may be 90 degrees, and FIG. 11 illustrates the bending angle θ1 of the body flange 220 and the bending angle θ2 of the cover flange 320 may be 75 degrees.

The bending angle θ1 of the body flange 220 and the bending angle θ2 of the cover flange 320 may vary depending on the thickness of the electrode assembly 100. The bending angle θ1 of the body flange 220 and the bending angle θ2 of the cover flange 320 may vary depending on the shape of the electrode assembly 100. For example, when the electrode assembly 100 is a stacked structure formed by stacking a negative electrode, a negative electrode, and a separator in one direction, the bending angle θ1 of the body flange 220 and the bending angle θ2 of the cover flange 320 may be formed to be 90 degrees. As another example, when the electrode assembly is a roll kind formed by winding a positive electrode, a negative electrode, and a separator, the bending angle θ1 of the body flange 220 and the bending angle θ2 of the cover flange 320 may be formed at an angle of less than 90 degrees, and have an inclined shape.

When the bending angle θ1 of the body flange 220 and the bending angle θ2 of the cover flange 320 are the same as each other, the body flange 220 and the cover flange 320 may be in surface contact with each other, and the bonding between the body 200 and the cover 300 may increase. For example, the body flange 220 and the cover flange 320 may be in surface contact with each other, so that a fixing strength and a welding area may increase during welding, thereby improving a welding quality.

Referring to FIG. 12 and FIG. 13, the bending angle θ1 of the body flange 220 and the bending angle θ2 of the cover flange 320 may be different from each other. The size of the secondary battery may be large enough to easily ensure a welding area between the body 200 and the cover 300, and the bending angle θ1 of the body flange 220 and the bending angle θ2 of the cover flange 320 may be formed differently from each other to be tightly welded to each other in a specific area.

For example, referring to FIG. 12, the bending angle θ1 of the body flange 220 may be smaller than the bending angle θ2 of the cover flange 320. In this case, one end of the cover flange 320 bent from the cover base 310 may be closely attached and coupled to the inner side of the body flange 220. According to some embodiments, one end of the cover flange 320 may be coupled to the inner side of the body flange 220 by a metal bonding method, such as welding, brazing, soldering, and/or the like.

As another example, referring to FIG. 3, the bending angle θ1 of the body flange 220 may be greater than the bending angle θ2 of the cover flange 320. In this case, an end of the cover flange 320 bent from the cover base 310 may be closely attached and coupled to one end of the body flange 220. The end of the cover flange 320 may be bonded to one end of the body flange 220 through a metal bonding method, such as welding, brazing, soldering, and/or the like.

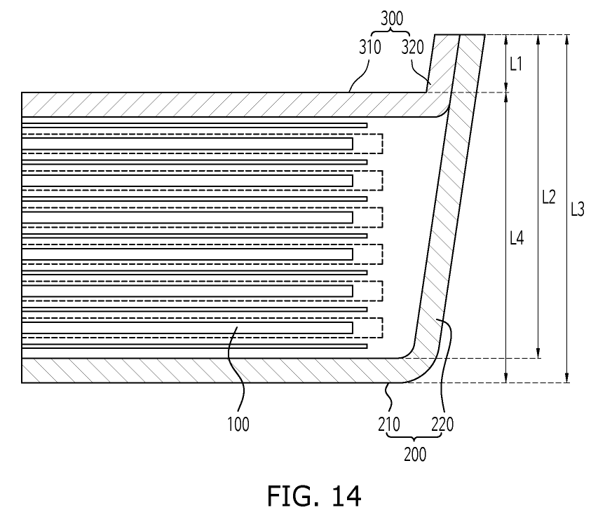

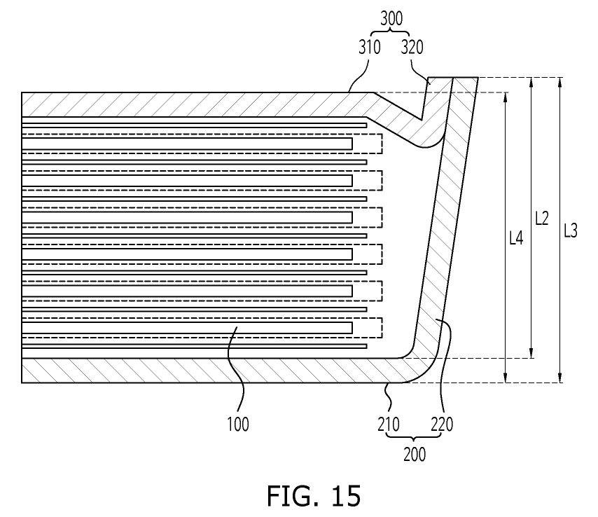

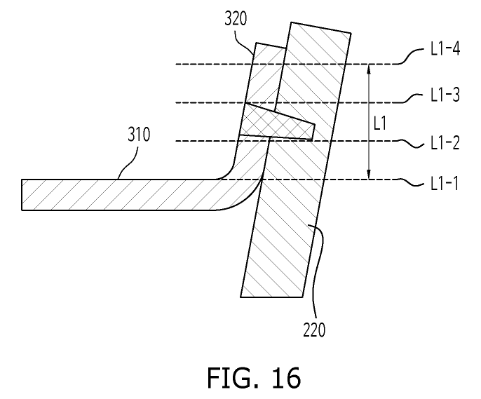

FIG. 14 is a cross-sectional view illustrating a state before an electrode assembly is expanded in a secondary battery according to some embodiments of the present disclosure. FIG. 15 is a cross-sectional view illustrating a state after an electrode assembly is expanded in a secondary battery according to some embodiments of the present disclosure. FIG. 16 is a view illustrating an example of a portion in which a body flange is coupled to a cover flange.

Referring to FIG. 14 to FIG. 16, an extension length L1 from the outer peripheral surface of the cover base 310 to one end of the cover flange 320 may be between 0.2 mm and 0.4 mm. The extension length L1 from the outer peripheral surface of the cover base 310 to one end of the cover flange 320 may be formed in consideration of an area in which the body 200 is bonded to the cover 300, and a length to be cut.

For example, a length from an outer peripheral surface L1-1 of the cover base 310 to a start point L1-2 of an area where the body flange 220 is bonded to the cover flange 320 may be 0.1 mm or more in consideration of a formability for forming the cover base 310 and the cover flange 320 by bending the cover 300. A length from the start point L1-2 of the area where the body flange 220 is bonded to the cover flange 320 to an end point L1-3 of an area where the body flange 220 is bonded to the cover flange 320 may be 0.1 mm or more in consideration of a degree to which a laser welding achieves a solid welding. A length from the end point L1-3 of the area where the body flange 220 is bonded to the cover flange 320 to one end L1-4 of the cover flange 320 may be set to secure a length (e.g., a predetermined length) from the welding area in consideration of a processing tolerance. The length L1 that extends from the outer peripheral surface of the cover base 310 to one end of the cover flange 320 may indicate a length from the outer peripheral surface L1-1 of the cover base 310 to the one end L1-4 of the cover flange 320.

For example, the length L1 extended from the outer peripheral surface of the cover base 310 to one end of the cover flange 320 may be 0.2 mm. The secondary battery case may include a relatively short body flange 220 and cover flange 320, thereby reducing the external size of the secondary battery and increasing the energy density.

The length L1 extended from the outer peripheral surface of the cover base 310 to one end of the cover flange 320 may be formed to be 7% or more or 15% or less of the length L2 extended from the inner side of the body base 210 to one end of the body flange 220. At least part of the body flange 220 of the body 200 and at least part of the cover flange 320 of the cover 300 may form the flange of the secondary battery by bonding (e.g., a metal bonding, such as welding, brazing, soldering, and/or the like).

The length L1 from the outer peripheral surface of the cover base 310 to one end of the cover flange 320 may be set in consideration of a thickness increase ratio of the secondary battery during a formation process and a long term use.

As the outer surface of the cover flange 320 is bonded to the inner surface of the body flange 220, an extra space surrounded (e.g., around a periphery thereof) by the cover base 310 and the cover flange 320 may be formed in the secondary battery. The extra space may be formed on the outer side in the thickness direction of the secondary battery. The extra space may indicate the space as the volume corresponding to the length L1 extended from the outer peripheral surface of the cover base 310 to one end of the cover flange 320. An entire thickness L3 of the secondary battery may correspond to the length from the outer peripheral surface of the body base 210 to one end of the body flange 220.

In the secondary battery, by repeating charging and discharging, the internal material may be vaporized, and a swelling phenomenon in which the internal material swells due to a pressure may occur. FIG. 14 and FIG. 15 shows examples of a secondary battery before and after swelling, respectively. The secondary battery according to an embodiment of the present disclosure may minimize or reduce a change in the volume of the secondary battery due to the swelling phenomenon by using the extra space caused by the flange formation, thereby achieving a higher energy density.

For example, the electrode assembly 100 may be formed by stacking a positive electrode, a negative electrode, and a separator in one direction. The electrode assembly 100 may be stacked in parallel to the body base 210 and the cover base 310. In this case, by repeating the charging and discharging of the secondary battery, the swelling of the secondary battery may occur in the direction perpendicular to the body base 210 and the cover base 310.

As another example, the electrode assembly 100 may be formed by winding an electrode and a separator. For example, the electrode assembly 100 may be a wound electrode assembly in which flat parts and curved parts are alternately formed. The electrode assembly 100 may be in a wound and flat form. In this case, as the secondary battery repeats charging and discharging, the swelling of the secondary battery may occur in the direction perpendicular to the body base 210 and the cover base 310.

When the electrode assembly 100 expands in the direction perpendicular to the body base 210 and the cover base 310, the cover base 310 may be deformed in the extension direction of the cover flange 320. When the cover base 310 is deformed in the extension direction of the cover flange 320, a length L4 from the outer peripheral surface of the body base 210 to the outer peripheral surface of the cover base 310 may vary. Accordingly, the extra space surrounded by the cover flange 320 may be reduced.

When the swelling occurs in the direction perpendicular to the body base 210 and the cover base 310, the cover base 310 may be deformed in the direction where the swelling occurs. In this case, the extra space on the outside in the thickness direction of the secondary battery may be absorbed into the space occupied by the secondary battery, the volume of the extra space may be reduced, and the energy density may increase.

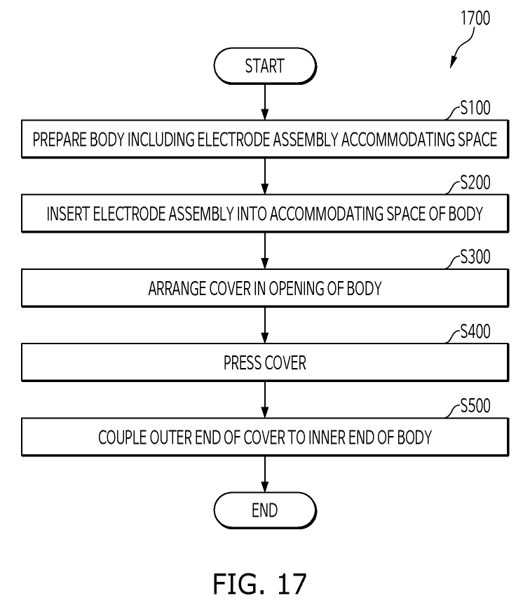

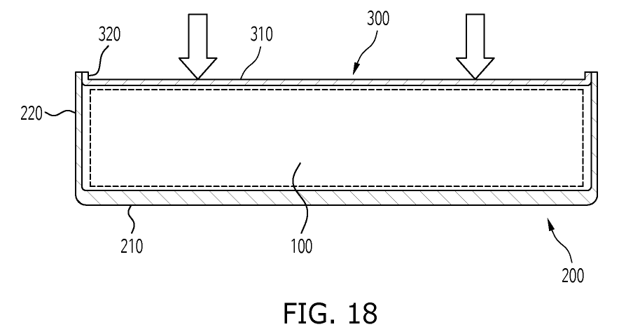

FIG. 17 is a flow chart illustrating an example of a method for manufacturing a secondary battery according to some embodiments of the present disclosure. FIG. 18 is a cross-sectional view illustrating an example of pressing a cover in a method for manufacturing a secondary battery according to some embodiments of the present disclosure.

A method for manufacturing a secondary battery 1700 may include preparing a body including an electrode assembly accommodating space (S100), inserting an electrode assembly into the accommodating space (S200), arranging a cover in an opening of the body (S300), pressing the cover (S400), and coupling an outer end of the cover to an inner end of the body (S500).

In more detail, the method for manufacturing the secondary battery may start, and a body may be prepared (S100). The preparing of the body in (S100) may include forming an opening, and preparing the body including an accommodating space that accommodates an electrode assembly. The body may include a body base, and a body flange extended by bending from the body base, and surrounding (e.g., around a periphery of) the body base.

In the inserting of the electrode assembly in (S200), the electrode assembly may be inserted into the accommodating space formed in the body. The body may be formed into a flat or substantially flat shape including the body base and the body flange, and may accommodate the electrode assembly in the accommodating space.

In the arranging of the cover in the opening of the body in (S300), the cover recessed toward the accommodating space may be arranged in the opening. The cover may include a cover base spaced apart from the body base with the accommodating space disposed therebetween, and a cover flange extended by bending from the cover base to surround (e.g., around a periphery of) the cover base and coupled to the inner side of the body flange. The arranging of the cover in the opening of the body in (S300) may include inserting the cover formed into a flat cup shape with the cover base and the cover flange, into the inside of the body, and arranging the cover in the opening.

In the pressing of the cover in (S400), the cover may be pressed while being in contact with the electrode assembly. As shown in FIG. 18, in the arranging of the cover in the opening of the body in (S300), the cover 300 inserted into the inside of the body 200 may contact the top of the electrode assembly 100. The electrode assembly 100 may be closely attached to the body 200 by pressing the outer upper surface of the cover 300.

In more detail, the pressing of the cover in (S400) may include pressing the upper surface of the cover base 310 of the cover 300 inserted into the inside of the body 200. In this case, the electrode assembly 100 may closely contact one surface of the body base 210 and one surface of the cover base 310. In the pressing of the cover in (S400), the outer peripheral surface of the electrode assembly 100 may closely contact one surface of the body base 210 and one surface of the cover base 310. Therefore, the electrode assembly 100 accommodated in the body 200 may be uniformly and closely attached, thereby inducing an excellent electrical chemical reaction without side reactions.

The coupling of the cover to the body in (S500) may include bonding the outer end of the cover to the inner end of the body. In more detail, the coupling of the cover to the body in (S500) may include bonding the body flange 220 to the cover flange 320 after the pressing of the cover in (S400) as shown in FIG. 18. For example, in the coupling of the cover to the body in (S500), at least part of an overlapping portion between the inner surface of the body flange 220 and the outer surface of the cover flange 320 may be bonded to each other.

According to some embodiments of the present disclosure, the method for manufacturing the secondary battery 1700 may further include cutting one end of the body flange and the cover flange coupled to each other in a direction parallel to the body base after the coupling of the cover to the body in (S500). For example, after the body 200 is bonded to the cover 300, at least part of the body flange and the cover flange may be cut by using a laser to improve the energy density of the secondary battery.

The flowchart of FIG. 17 described above are provided as an example, and the present disclosure is not limited to the flowchart of FIG. 17 described above. For example, one or more processes in the flowchart may be added/changed/deleted, the order of one or more processes may be changed, and/or one or more processes may be performed concurrently (e.g., simultaneously or substantially simultaneously) with each other.

The foregoing is illustrative of some embodiments of the present disclosure, and is not to be construed as limiting thereof. Although some embodiments have been described, those skilled in the art will readily appreciate that various modifications are possible in the embodiments without departing from the spirit and scope of the present disclosure. It will be understood that descriptions of features or aspects within each embodiment should typically be considered as available for other similar features or aspects in other embodiments, unless otherwise described. Thus, as would be apparent to one of ordinary skill in the art, features, characteristics, and/or elements described in connection with a particular embodiment may be used singly or in combination with features, characteristics, and/or elements described in connection with other embodiments unless otherwise specifically indicated. Therefore, it is to be understood that the foregoing is illustrative of various example embodiments and is not to be construed as limited to the specific embodiments disclosed herein, and that various modifications to the disclosed embodiments, as well as other example embodiments, are intended to be included within the spirit and scope of the present disclosure as defined in the appended claims, and their equivalents.

### DESCRIPTION OF SOME REFERENCE SYMBOLS

10: Secondary Battery

100: Electrode Assembly

200: Body

201: Opening

202: Accommodating Space

210: Body Base

220: Body Flange

300: Cover

310: Cover Base

320: Cover Flange

What is claimed is:

1. A secondary battery case comprising:
a body having an opening at one end, and an accommodating space for accommodating an electrode assembly; and
a cover coupled to the one end with the opening to seal the accommodating space, the cover being recessed from the opening toward the accommodating space,
wherein an outer end of the cover is coupled to an inner end of the body.

2. The secondary battery case as claimed in claim 1, wherein the body comprises:
a body base; and
a body flange extending by being bent from the body base, and surrounding around the body base, and
wherein the cover comprises:
a cover base spaced from the body base with the accommodating space therebetween; and
a cover flange extending by being bent from the cover base, and surrounding around the cover base, the cover flange being coupled to an inner side of the body flange.

3. The secondary battery case as claimed in claim 2, wherein an extension direction of the cover flange is same as an extension direction of the body flange.

4. The secondary battery case as claimed in claim 2, wherein a bending angle of the body flange and a bending angle of the cover flange are same as each other, and
wherein the bending angle of the body flange and the bending angle of the cover flange is from 75 degrees to 90 degrees.

5. The secondary battery case as claimed in claim 2, wherein a bending angle of the body flange is smaller than a bending angle of the cover flange.

6. The secondary battery case as claimed in claim 2, wherein a bending angle of the body flange is greater than a bending angle of the cover flange.

7. The secondary battery case as claimed in claim 2, wherein a length from an outer peripheral surface of the cover base to one end of the cover flange is between 0.2 mm and 0.4 mm.

8. The secondary battery case as claimed in claim 2, wherein a length from an outer peripheral surface of the cover base to one end of the cover flange is 7% or more and 15% or less than a length from an inner peripheral surface of the body base to one end of the body flange.

9. The secondary battery case as claimed in claim 1, wherein a thickness of the body is one time or two times a thickness of the cover.

10. The secondary battery case as claimed in claim 1, wherein the body and the cover comprise a same metal material as each other.

11. The secondary battery case as claimed in claim 10, wherein the metal material comprises stainless use steel.

12. A secondary battery comprising:
an electrode assembly comprising a first electrode, a separator, and a second electrode;
a body comprising one end with an opening, and an accommodating space accommodating the electrode assembly; and
a cover coupled to the one end with the opening to seal the accommodating space, the cover being recessed from the opening toward the accommodating space,
wherein an outer end of the cover is coupled to an inner end of the body.

13. The secondary battery as claimed in claim 12, wherein the body comprises:
a body base; and
a body flange extending by being bent from the body base, and surrounding around the body base, and
wherein the cover comprises:
a cover base spaced from the body base with the accommodating space therebetween; and
a cover flange extending by being bent from the cover base to surround around the cover base, and coupled to an inner side of the body flange.

14. The secondary battery as claimed in claim 13, wherein the cover base is configured to be deformable in an extension direction of the cover flange when the electrode assembly expands in a direction perpendicular to the body base and the cover base.

15. The secondary battery as claimed in claim 13, wherein an extension direction of the cover flange is same as an extension direction of the body flange.

16. The secondary battery as claimed in claim 13, wherein a length from an outer peripheral surface of the cover base to one end of the cover flange is 7% or more and 15% or less than a length from an inner peripheral surface of the body base to one end of the body flange.

17. A method for manufacturing a secondary battery, the method comprising:
preparing an opening at one end of a body of a case, and an accommodating space for accommodating an electrode assembly in the body;
inserting the electrode assembly into the accommodating space;
arranging a cover recessed toward the accommodating space in the opening;
pressing the cover to be in contact with the electrode assembly; and
coupling an outer end of the cover to an inner end of the body.

18. The method as claimed in claim 17, wherein the body comprises:
a body base; and
a body flange extending by being bent from the body base, and surrounding around the body base, and
wherein the cover comprises:
a cover base spaced from the body base with the accommodating space therebetween; and
a cover flange extending by being bent from the cover base to surround around the cover base, and coupled to an inner side of the body flange.

19. The method as claimed in claim 18, wherein, in the pressing of the cover, an outer peripheral surface of the electrode assembly is in contact with one surface of the body base and one surface of the cover base.

20. The method as claimed in claim 18, further comprising:
cutting one end of the body flange and the cover flange that are coupled to each other to be parallel to the body base.
